(19) United States
(12) Patent Application Publication
(10) Pub. No.: US 2007/0025746 A1
(43) Pub. Date: Feb. 1, 2007

(54) Sheet identification machine

(76) Inventors: Yasutoshi Hayashi, Takatsuki (JP); Eisuke Shiomi, Nagakute (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/444,475

(22) Filed: Jun. 1, 2006

(30) Foreign Application Priority Data
Jul. 26, 2005 (JP) 2005-215921

(51) Int. Cl. G03G 15/00

(52) U.S. Cl. 399/21

(57) ABSTRACT

The invention provides a sheet identification machine in which a sensor portion and a facing portion can be easily and accurately positioned regardless of a level of skill of a worker. Accordingly, a sheet identification machine (10) is provided with a magnetic sensor portion (40) having a magnetic sensor (45) detecting for identification from a sheet, a facing roller portion (50) arranged so as to face to the magnetic sensor portion (40), and an energizing portion (60) energizing the facing roller portion (50) in a direction moving close to the magnetic sensor portion (40), thereby bringing the positioning bearing (51) into contact with the positioning member (42).

### INCORPORATION BY REFERENCE

The present application claims priority from Japanese application JP 2005-215921 filed on Jul. 26, 2005, the content of which is hereby incorporated by reference into this application.

### BACKGROUND OF THE INVENTION

### Field of the Invention

The present invention relates to a sheet identification machine identifying the money kind and the truth of a sheet, for example, represented by a bank bill, and more particularly to a sheet identification machine in which positions of a sensor portion and a facing portion can be easily adjusted.

Conventionally, the sheet identification machine is provided with various sensors such as an optical sensor, a magnetic sensor, a pressure sensitive sensor or the like, for identifying the kind and the truth of the sheet. In these sensors, it is necessary to adjust the position for securing a sufficient precision of identification, and the position adjustment is executed by screwing or the like at a time of manufacturing.

As an apparatus for adjusting the position of the sensor, there has been proposed a magnetic head mounting and adjusting apparatus (refer to patent document 1). The magnetic head mounting and adjusting apparatus corresponds to an apparatus which can adjust such that the slit surface is positioned at a contact portion with the sheet, by structuring a magnetic head having a curved leading end and provided with a slit surface for detecting a pattern in a part of the leading surface such as to be rotatable while keeping a state in which the curved surface is brought into contact with the sheet.

On the basis of the magnetic head mounting and adjusting apparatus, it is possible to easily adjust an attitude of the magnetic head in the case that the slit of the magnetic head exists at a deviated position.

However, even if the attitude is easily adjusted, the adjustment is executed by a worker, and the adjustment is executed by a man power as usual. Accordingly, a reading precision of the magnetic head after adjusting the attitude and a working time required for adjusting the attitude are greatly affected by an experience and a level of skill of the worker.

On the other hand, as long as carrying and identifying the sheet, there is generated a trouble that the sheet clogs near the sensors during the operation. In such a case, if it is intended to pick up the clogged sheet, the sensors form an obstacle.

In this case, it is preferable to remove the clogged sheet without touching the sensors, however, in the case that the clogged sheet can not be removed until the sensors are temporarily detached, there is generated a necessity that the positions of the sensors are again adjusted after removing the clogged sheet.

In the magnetic head mounting and adjusting apparatus mentioned above, it is necessary to execute the same adjustment as the original adjustment again in the case of executing the readjustment mentioned above, and the readjustment can not be omitted.

Patent Document 1

JP-A-52-121309

### SUMMARY OF THE INVENTION

The present invention is made by taking the problem mentioned above into consideration, and an object of the present invention is to provide a sheet identification machine in which a sensor portion and a facing portion can be easily and accurately positioned after a maintenance regardless of a level of skill of a worker.

In accordance with the present invention, there of provided a sheet identification machine, wherein the sheet identification machine is provided with an energizing portion energizing at least one of the sensor portion and the facing portion in a direction moving close to each other, thereby bringing a part of the one into contact with a part of the other.

Further, a carrier path is formed between facing surfaces of a base and a cover, any one of the sensor portion and the facing portion is arranged in the base, the other is arranged in the cover, and a locking portion locking an opening and closing operation between the cover and the base is provided.

Further, the sheet identification machine is provided with a hooking detecting means for detecting a matter that a hook portion serving as the lock portion is hooked to an engagement portion.

In accordance with the present invention, it is possible to provide a sheet identification machine which can easily and accurately position the sensor portion and the facing portion after the maintenance regardless of the level of skill of the worker.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of an automatic teller machine (ATM);

FIG. 2 is a view of an internal structure of a bank bill processing apparatus installed in the ATM;

FIG. 3 is a perspective view of a sheet identification machine in which a main body unit is in an open state, as seen from a rear side;

FIG. 4 is a perspective view of the sheet identification machine in which the main body unit is in an open state, as seen from a front side;

FIG. 5 is a perspective view of the sheet identification machine in which the main body unit is in the process of being closed, as seen from the front side;

FIG. 6 is a perspective view of the sheet identification machine in which the main body unit is in a closed state, as seen from the front side;

FIG. 7 is a perspective view of the main body unit is in the closed state, as seen from the rear side;

FIG. 8 is a bottom elevational view showing a magnetic sensor portion;

FIG. 9 is a plan view showing a facing roller portion;

FIG. 10 is a cross sectional view of the bank bill processing apparatus as seen from a front surface;

FIG. 11 is a perspective view of the magnetic sensor portion and the facing roller portion;

FIG. 12 is a cross sectional view of the magnetic sensor portion and the facing roller portion as seen form a right side surface;

FIG. 13 is an explanatory view explaining a positioning operation of the magnetic sensor portion and the facing roller portion;

FIG. 14 is a perspective view of a hook portion as seen from a rear side; and

FIG. 15 is an explanatory view of a hooking operation of the hook portion.

### DESCRIPTION OF THE EMBODIMENTS

A description will be given below of an embodiment in accordance with the present invention with reference to the accompanying drawings.

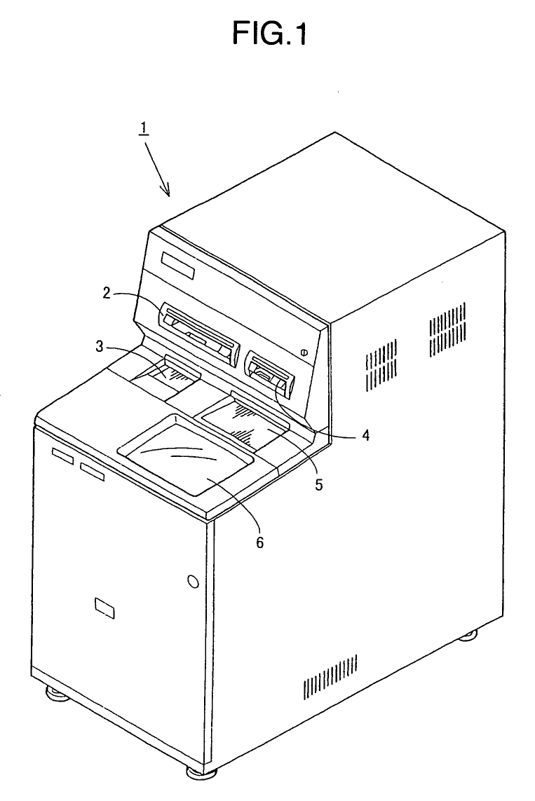

FIG. 1 shows a perspective view of an automatic teller machine (ATM) 1 installed in a financial institution such as a bank or the like, which corresponds to one of automatic transaction apparatuses. The ATM 1 is provided with a passbook insertion port 2 allowing an insertion of a passbook, a coin input and output port 3 inputting and outputting a coin, a card insertion port 4 allowing an insertion of a card, a bank bill input and output port 5 inputting and outputting a bank bill, and a cathode ray tube (CRT) 6 doubling as a touch panel displaying and guiding a transaction operation to a customer, in an upper front surface of an apparatus main body. In accordance with the structure mentioned above, the ATM 1 allows a transaction such as a money input, a money output, a funds transfer, a passbook entry, a balance inquiry and the like.

A description will be given of a handling operation of the ATM 1. A control apparatus (not shown) provided in an inner portion of the ATM 1 displays a guide information for various transactions such as an input guide per a transaction item, an operating procedure, an acceptance guide and the like on the CRT 6, and executes the transaction touch input by the customer on the basis of the display.

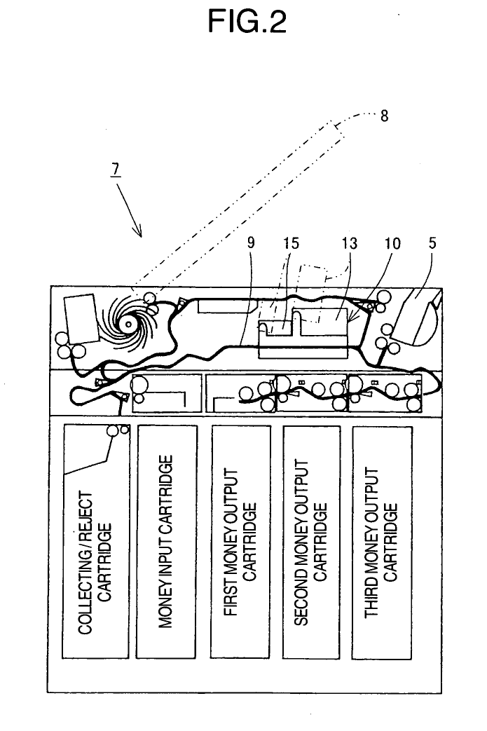

FIG. 2 shows a view of an internal structure of a bank bill processing apparatus 7 installed in the ATM 1. The bank bill processing apparatus 7 is structured such that the bank bill input and output port 5 which the customer inputs and outputs the bank bill to and from is opened to one side in an upper portion, and a bank bill identification machine 10 identifying the truth of the bank bill and identifying the money kind of the bank bill is provided in an inner side communicated with the bank bill input and output port 5 by a carrier path 9.

A rear stage of the bank bill identification machine 10 is provided with a temporary reservation portion temporarily reserving the bank bill conducted to the bank bill identification machine 10 in the case of judging that it is right, and a return reservation portion returning and reserving an identification failure bank bill in the case of judging that it is failed to be identified, so as to be communicated by the carrier path 9.

Further, in a further rear stage thereof, there are provided with respective feeding units delivering the bank bill from first to third money output cartridges to the carrier path 9, an accumulation unit delivering the bank bill to the money input cartridge from the carrier path 9, and a collecting and reject cartridge directly receiving the bank bill from the carrier path 9.

A top plate 8 of the bank bill processing apparatus 7 is pivoted so as to be openable as shown by a dotted line in the drawing. Further, a cover 13 and an expansion cover 15 are pivoted to the bank bill identification machine 10 so as to be openable as shown by a dotted line in the drawing. The top plate 8, the cover 13 and the expansion cover 15 are structured so as to be opened and closed in the same direction.

In accordance with the structure mentioned above, the bank bill processing apparatus 7 can execute a carrier process in correspondence to a process command such as a money input process, a money output process, a complete checking process or the like. Since the top plate 8 can be opened at a time of executing a maintenance such as a case that the bank bill is clogged in the carrier path 9, it is possible to easily execute the maintenance.

Since the cover 13 and the expansion cover 15 can be opened in the same direction as the top plate 8 particularly at a time when the maintenance of the bank bill identification machine 10 is necessary such as a case that the bank bill is clogged within the bank bill identification machine 10, the worker can open the top plate 8, the cover 13 and the expansion cover 15 at the same standing position, so that the work can be easily executed and the maintenance can be easily executed.

Next, a description will be given of a structure of the bank bill identification machine 10.

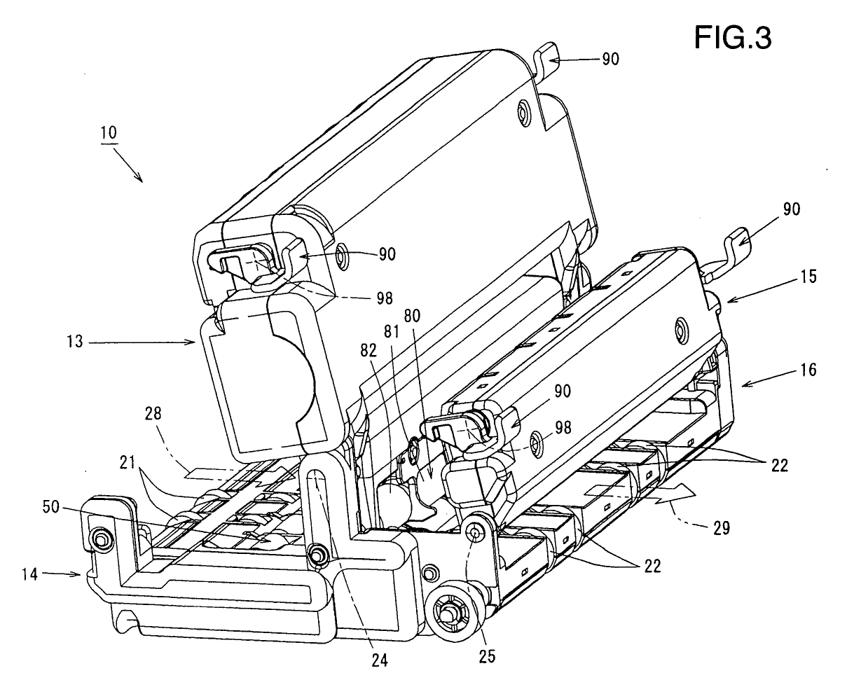

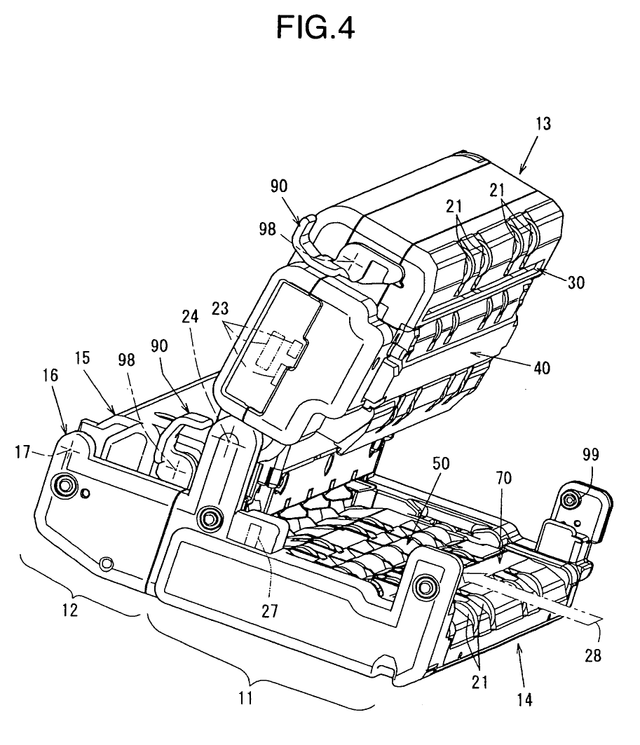

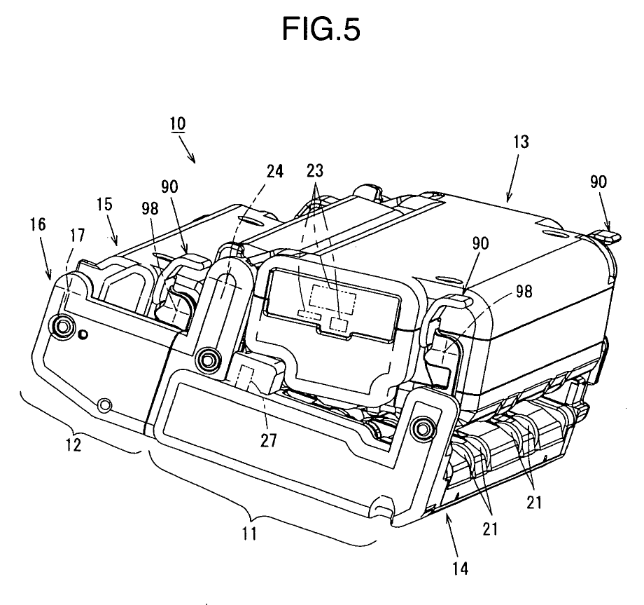

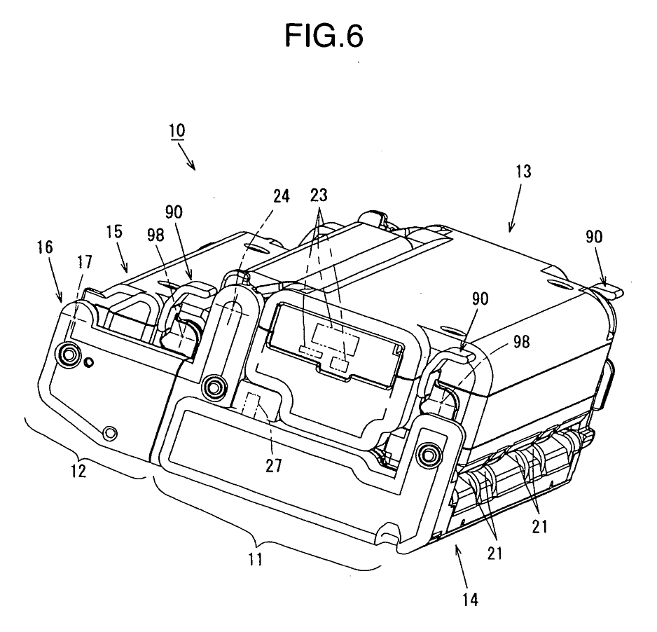

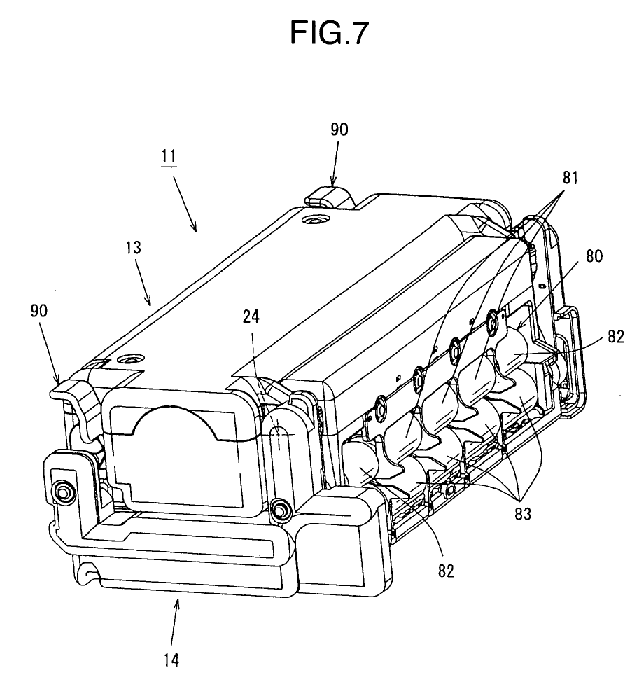

FIG. 3 shows a perspective view of the bank bill identification machine 10 in a state in which a main body unit 11 and an expansion unit 12 are in an open state, as seen from a rear side, FIG. 4 shows a perspective view of the bank bill identification machine 10 in a state in which the main body unit 11 is in an open state and the expansion unit 12 is in a closed state, as seen from a front side, FIG. 5 shows a perspective view of the bank bill identification machine 10 in a state in which the main body unit 11 is in the process of closing and the expansion unit 12 is in a closed state, as seen from the front side, FIG. 6 shows a perspective view of the bank bill identification machine 10 in a state in which the main body unit 11 and the expansion unit 12 are in the closed state, as seen from the front side, and FIG. 7 shows a perspective view of the bank bill identification machine 10 in a state in which the expansion unit 12 is detached and the main body unit 11 is in the closed state, as seen from the rear side.

The bank bill identification machine 10 is structured such that the expansion unit 12 is connected to a rear side (a left side in FIG. 4) of the main body unit 11. The main body unit 11 is structured such that the cover 13 is pivoted to a base 14 by a rotating shaft 24, and the expansion unit 12 is structured such that the expansion cover 15 is pivoted to an expansion base 16 by a rotating shaft 25.

A carrier path 28 (refer to FIG. 4) is provided between facing surfaces where the cover 13 and the base 14 face to each other in the closed state, and is structured such that the bank bill is carried by a plurality of rollers 21 arranged up and down in the cover 13 and the base 14 in a facing manner.

Further, the expansion unit 12 is structured such that a carrier path 29 (refer to FIG. 3) is provided between facing surfaces where the expansion cover 15 and the expansion base 16 face to each other in the closed state, and the bank bill is carried by a plurality of rollers 21 arranged up and down in the expansion cover 15 and the expansion base 16 in a facing manner.

The carrier path 28 and the carrier path 29 are continuously provided in a straight line, and are structured such as to linearly carry the bank bill accepting from a front side of the main body unit 11 and discharge from the rear side of the expansion unit 12.

Further, since the cover 13 and the expansion cover 15 are independently opened and closed in the same direction as shown in FIG. 3, and is independently opened and closed in the same direction as the top plate 8 of the ATM 1 (refer to a virtual line in FIG. 2), it is possible to easily execute a work after opening the cover 13 (for example, a work for removing the clogged bank bill or the like).

The cover 13 is provided with an image sensor portion 30 (refer to FIG. 4) and a magnetic sensor portion 40 (refer to FIG. 4) in this order from the front side, in the facing surface (the lower surface) to the carrier path 28.

A hook portion 90 rotatably pivoted to a rotating shaft 98 which is in parallel to a carrier width direction of the carrier path 28 is independently provided in a front portion of each of right and left side surfaces of the cover 13 symmetrically. In this case, both the right and left hook portions 90 and 90 may be structured such as to be coupled in such a manner as to work with each other and simultaneously rotate at the same angle.

Three connection connectors 23 for electrically connecting to the ATM 1 are provided at an approximately center position of a left side surface of the cover 13. Accordingly, electric elements such as the roller 21, the image sensor portion 30, the magnetic sensor portion 40 and the like provided in the cover 13 can be supplied an electric power, can receive various control signals, and can transmit the detected detection signal to the ATM 1.

The base 14 is provided with a light source portion 70 (refer to FIG. 4), a facing roller portion 50 (refer to FIG. 4) and a plurality of fixing rollers 83 (refer to FIG. 7) in this order from the front side, in the facing surface (the upper surface) to the carrier path 28.

In this case, a plurality of fixing rollers 83 are constituted by a cylindrical roller formed in a solid cross sectional shape by a metal member which has a high hardness and is not deformed, such as a stainless steel or the like, is provided with a rotating shaft in parallel to the carrier width direction and rotates in the carrying direction.

A pressure sensitive sensor portion 80 is provided in an upper side of the fixing roller 80 while pinching the carrier path 28 (refer to FIG. 3) therebetween. The pressure sensitive sensor portion 80 is structured, as shown in FIG. 7, such that three displacement rollers 81 are rotatably pivoted to a rotating shaft in the carrier width direction, and right and left outer sides thereof are provided with rubber rollers 82 corresponding to rollers in which at least an outer periphery thereof is formed by an elastic member such as a deformable rubber or the like, one by one. The displacement roller 81 and the rubber roller 82 are arranged in an upper side of the fixing roller 83 so as to face to the fixing roller 83.

The displacement roller 81 is structured such that an outer peripheral surface is formed by a metal member which has a high hardness and is not deformed such as a stainless steel or the like, and an elastic body such as a rubber which can be elastically deformed is provided in an inner side thereof. In accordance with the structure, when the bank bill passes through the carrier path 28, the elastic body is deformed on the basis of only a thickness of the bank bill and the displacement roller 81 (accurately the outer periphery of the displacement roller 81) is lifted up. The thickness of the bank bill is detected by detecting an ascending distance (a displacement distance toward the upper side) by a sensor (not shown).

The displacement roller 81 is arranged so as to be directly fixed to the rotating shaft of the cover 13, and is structured such that the displacement roller 81 does not move even if the cover 13 is opened. Accordingly, with respect to the detection of the bank bill thickness in which a precision is most required for adjusting the vertical position, no error is generated in the precision of detecting the thickness by the displacement roller 81 however often the cover 13 is opened and closed, and it is possible to always achieve the thickness detection with a high precision.

Further, since the rollers in both end portions are constituted by the rubber roller 82, it is possible to prevent the thickness of the bank bill from being erroneously detected. In other words, in the case that the rollers coaxially provided side by side in the carrier width direction are all constituted by the displacement roller 81, end portions of the bank bill is caught in the displacement rollers 81 in both end portions, and the bank bill is not caught in the center of the displacement roller 81. In this case, the displacement roller 81 is tilted, and there is a possibility that the true bank bill is detected as an abnormal thickness. However, in this embodiment, since both end portions of the rollers coaxially provided in line in the carrier width direction are structured by the rubber rollers 82, and the thickness in this part is not detected, it is possible to prevent the displacement roller 81 from being tilted on the basis of the catching degree of the bank bill so as to erroneously detect the thickness of the bank bill.

Further, the connection connector 27 for electrically connecting to the ATM 1 is provided in an approximately center position of a left side surface of the base 14. Accordingly, the electric elements such as the roller 21, the facing roller 50, the light source portion 70 and the like provided in the base 14 can be supplied the electric power, can receive the various control signals and can transmit the detected detection signal to the ATM 1.

In accordance with the structure mentioned above, the bank bill identification machine 10 can execute the money kind identification and the truth identification by the image sensor portion 30, the magnetic sensor portion 40 and the pressure sensitive sensor portion 80 during carrying the bank bill by the carrier path 28.

Further, in the case that the bank bill is clogged within the carrier path 28, the worker can open the cover 13 so as to easily remove the clogged bank bill. Further, in the case that the bank bill is clogged within the carrier path 29, the worker can open the expansion cover 15 so as to easily remove the clogged bank bill.

Further, since the bank bill identification machine 10 can execute the money kind identification and the truth identification on the basis of the image sensor portion 30, the magnetic sensor portion 40 and the pressure sensitive sensor portion 80, only by the main body unit 11 from which the expansion unit 12 is detached, the bank bill identification machine 10 can be attached to a wide variety of automatic transaction apparatuses such as the ATM, a money changer, a ticket machine and the like without applying any specific modification to the main body unit 11.

Further, since various sensors can be freely attached to the expansion unit 12, for example, even in the case that a new bank bill is issued in place of the conventional bank bill and a new sensor is necessary for improving a precision of the money kind identification and the truth identification of the new bank bill, it is possible to correspond thereto only by attaching the sensor to the expansion unit 12. Further, it is possible to correspond to an addition of money kinds for foreign bank bills only by adding the sensors. Accordingly, it is possible to provide the bank bill identification machine 10 having a high expandability.

In addition, since the expansion unit 12 is structured such that the expansion cover 15 is opened, it is possible to easily execute the maintenance by opening the expansion cover 15 even if the trouble such as the clogging of the bank bill is generated within the expansion unit 12.

Further, even in the actually operated bank bill identification machine 10, since it is possible to attach a novel sensor by opening the expansion cover 15 in the field without temporarily moving the bank bill identification machine from the operated place to a manufacturer, it is possible to provide a high-quality maintenance service for a short time.

Further, since the image sensor potion 30 having a longest processing time is arranged in the front side, and the pressure sensitive sensor portion 80 having a shortest processing time is arranged in the rear side, the bank bill passes one by one from the sensor portion having the long processing time, and it is possible to shorten an entire processing time.

Next, a description will be given of a structure of the magnetic sensor portion 40 and the facing roller portion 50.

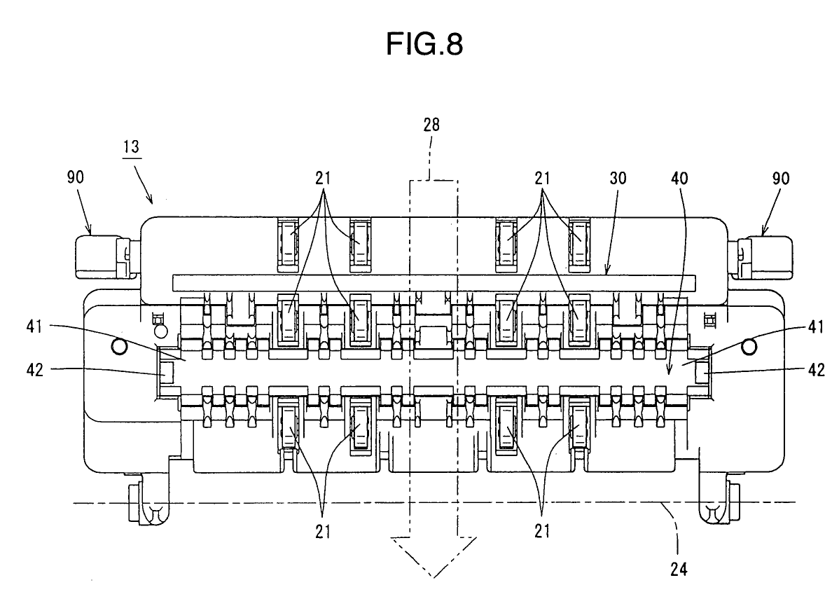

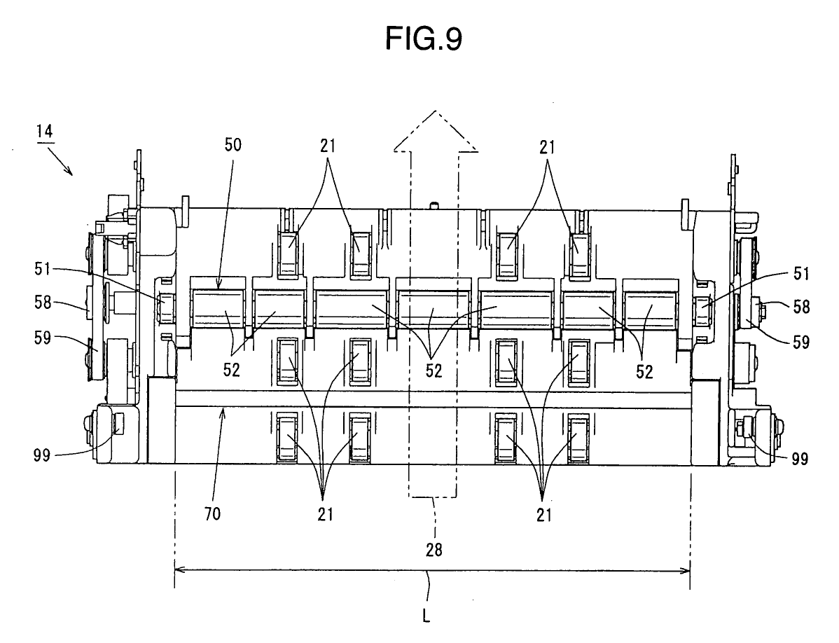

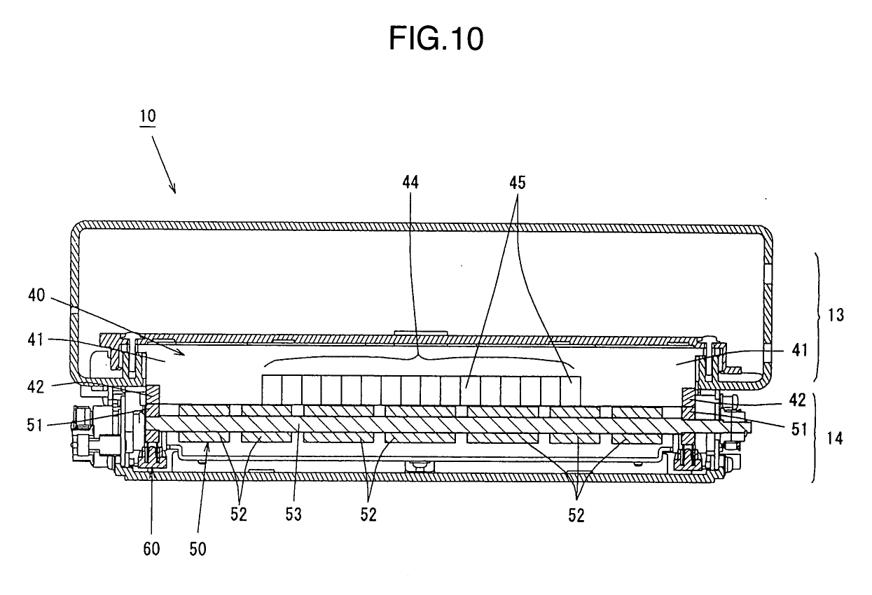

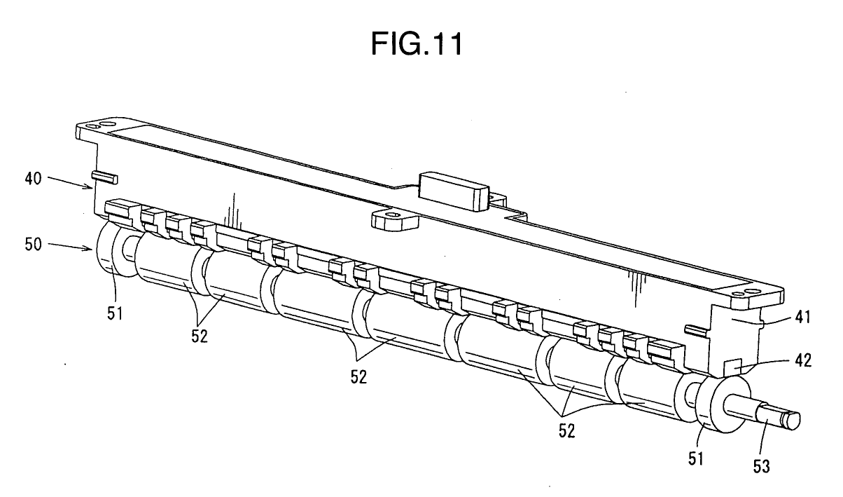

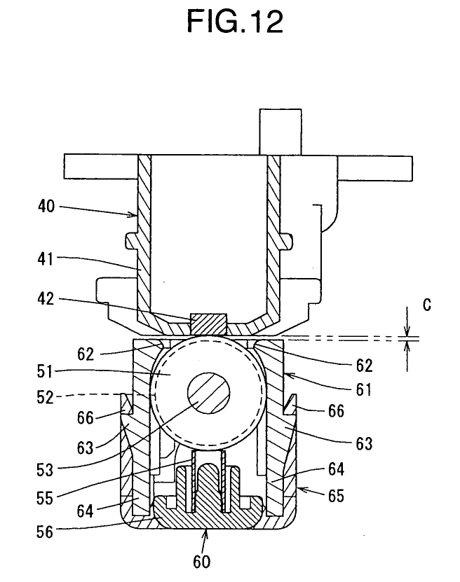

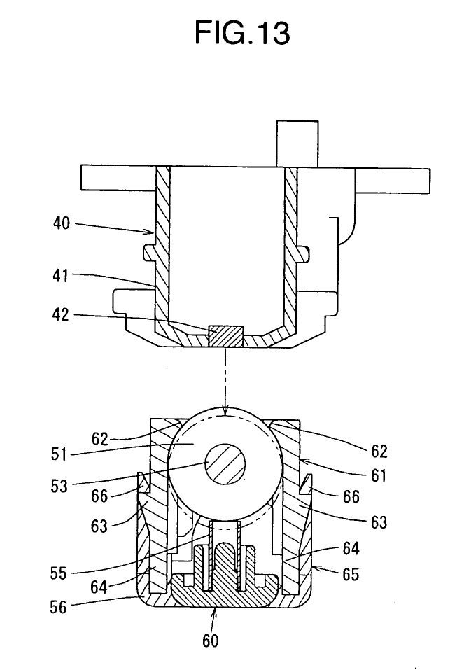

FIG. 8 is a view of the structure of the magnetic sensor portion 40, FIG. 9 is a view of the structure of the facing roller portion 50, FIG. 10 is a cross sectional view of the bank bill identification machine 10 as seen from the front surface, FIG. 11 is a perspective view of the magnetic sensor portion 40 and the facing roller portion 50, FIG. 12 is a cross sectional view of the magnetic sensor portion 40 and the facing roller portion 50 as seen from a right side surface, and FIG. 13 is an explanatory view explaining a positioning operation of the magnetic sensor portion 40 and the facing roller portion 50.

The magnetic sensor portion 40 is constituted by a support body 41, a plurality of magnetic sensors 45 (refer to FIG. 10) and two positioning members 42 as shown in FIG. 10, and both right and left side ends of the support body 41 are firmly attached to the cover 13 by screwing.

The support body 41 is formed so as to be elongated in the carrier width direction by an aluminum corresponding to one of high-permeability members, and a lower surface thereof is formed as a straight flat surface having no concavity and convexity.

The positioning member 42 is formed by a stainless steel corresponding to one of metal members having a high hardness. The positioning member 42 is buried in both side portions in a longitudinal direction of the lower surface of the support body 41 in such a manner that the lower surface of the support body 41 and the lower surface of the positioning member 42 are flush. A position of the positioning member 42 is close to a screwing position of the support body 41.

The magnetic sensor 45 is buried in a sensor accommodating hole 44 provided in the lower surface of the support body 41, and is structured such that the lower surface of the magnetic sensor 45 is flush with the lower surface of the support body 41. A layout of the magnetic sensor 45 can be freely set in correspondence to the bank bill to which the bank bill identification machine 10 is provided, however, the structure is made, for example, such that the magnetic sensors 45 are provided one by one or two by two in both ends of the sensor accommodating hole 44, are provided at a plurality of positions densely with a narrow space in a center portion of the sensor accommodating hole 44, and are provided roughly with a wide space between the center portion and both the end portions.

In the case that the magnetic sensors are arranged as mentioned above, it is possible to intensively detect an important information from the carried bank bill, and it is possible to more effectively detect at a higher precision in comparison with a case that the magnetic sensors 45 are evenly arranged. Further, it is possible to provide the magnetic sensors 45 at a lower cost in comparison with a case that the magnetic sensors 45 are evenly arranged intensively, and it is possible to shorten a required time for the identification process. Further, it is possible to suitably correspond to various bank bills having different sizes.

The facing roller portion 50 is constituted by a shaft body 53, a plurality of facing rollers 52 and a positioning bearing 51.

The shaft body 53 is pivoted by both ends of the carrier width of the carrier path 28 in such a manner as to rotate around a rotating shaft which is in parallel to the transfer width direction. Drive rollers 58 and 58 are firmly attached to both ends of the shaft body 53 as shown in FIG. 9, and are rotated in the carrier direction by a driving force of an appropriate driving means such as a stepping motor or the like through belts 59 and 59 wound around the drive rollers 58 and 58.

The facing rollers 52 are arranged seven horizontally in line in the carrier width direction, and the shaft body 53 is inserted to the rotating shaft of each of the facing rollers 52. The plurality of facing rollers 52 are structured such that all the diameters are identical, and all the facing rollers 52 are firmly attached to the shaft body 53 so as to rotate together with the rotation of the shaft body 53. A rotating speed of the facing roller 52 is identical to a rotating speed of the roller 21 in the carrier direction, and the roller 21 and the facing roller 52 are synchronized.

The positioning bearing 51 corresponds to a bearing in which a diameter thereof is a little larger than the facing roller 52, and is arranged at a position facing to the positioning member 42 of the magnetic sensor portion 40, as shown in FIG. 10, at a position close to both end portions of the shaft body 53. Two positioning bearings 51 are arranged in such a manner that each of them is positioned in an outer side of a carrier path width L (refer to FIG. 9) of the carrier path 28. Accordingly, it is possible to avoid the bank bill in the process of being carried from coming into collision with the positioning bearing 51.

The facing roller portion 50 structured as mentioned above is supported by an energizing portion 60 provided symmetrical in both right and left end portions of the facing roller portion 50 so as to be movable upward and downward, as shown in FIG. 12.

The energizing portion 60 is constituted by a spring 55, a spring holder 56, an accommodating cover 61 and an accommodating case 65.

The accommodating case 65 is provided with engagement projections 66 and 66 having a U-shaped cross section and inside protruding to both upper end portions symmetrically in front and rear sides (right and left sides in FIG. 12).

The accommodating cover 61 is entirely formed in an inverted-U-shaped cross section, and is provided with two leg portions 64 which is long in a vertical direction, in parallel at an interval of the same width as the diameter of the positioning bearing 51. Engagement projections 63 and 63 protruding to an outer side in a longitudinal direction (a lateral direction in FIG. 12) are symmetrically provided in center portions in the vertical direction of the respective leg portions 64. Accordingly, it is possible to engage and fix the engagement projection 66 and the engagement projection 63 only by fitting the accommodating cover 61 to the accommodating case 65.

An upper line of the accommodating cover 61 is provided with a hole 62 in which a length in the longitudinal direction (the lateral direction in FIG. 12) is a little shorter than the diameter of the positioning bearing 51, and a length in the carrier width direction (a depth direction in FIG. 12) is longer than a thickness of the positioning bearing 51. Accordingly, an upper end portion of each of the leg portions 64 protrudes a little to an inner side. Therefore, the positioning bearing 51 is accommodated in such a manner that a part of the positioning bearing 51 can protrude from the upper surface of the accommodating cover 61, however, the positioning bearing 51 itself can not get out.

The spring holder 56 holds a helical coil spring 55 in a lower side, and is installed to an inner side of a bottom portion of the accommodating case 65. Accordingly, the spring 55 can be stably expanded and contracted in the vertical direction.

The energizing portion 60 structured as mentioned above supports the positioning bearing 51 in such a manner as to be stably movable upward and downward without being deviated in the longitudinal direction, while being energized to the upper side by the spring 55.

In accordance with the structure mentioned above, when the cover 13 is in the open state (refer to FIG. 2), the positioning bearing 51 is prevented from coming off by the hole 62 while being energized to the upper side on the basis of the energizing force of the spring 55, as shown in FIG. 13.

Further, if the cover 13 is closed to the closed state (refer to FIG. 6) as shown by an arrow in FIG. 13, the positioning member 42 is brought into contact with the positioning bearing 51 so as to execute a downward pressing operation, and the facing roller portion 50 is entirely pressed downward on the basis of the operation.

In this state, a clearance C is formed between the lower surface of the magnetic sensor portion 40 (the lower surface of the magnetic sensor portion 45) and the topmost surface of the facing roller 52 as shown in FIG. 12. The clearance C corresponds to a distance at which the bank bill can pass through and the magnetic sensor 45 can rightly detect the information of the bank bill, and is formed as a distance, for example, about 0.3 mm.

Accordingly, the right clearance C can be formed only by closing the cover 13, and it is possible to keep a detecting precision of the magnetic sensor 45 at a high precision regardless of the level of skill of the worker executing the opening and closing work of the cover 13.

Next, a description will be given of a structure of the hook portion 90 and an operation that the hook portion 90 hooks on a coupling bearing 99.

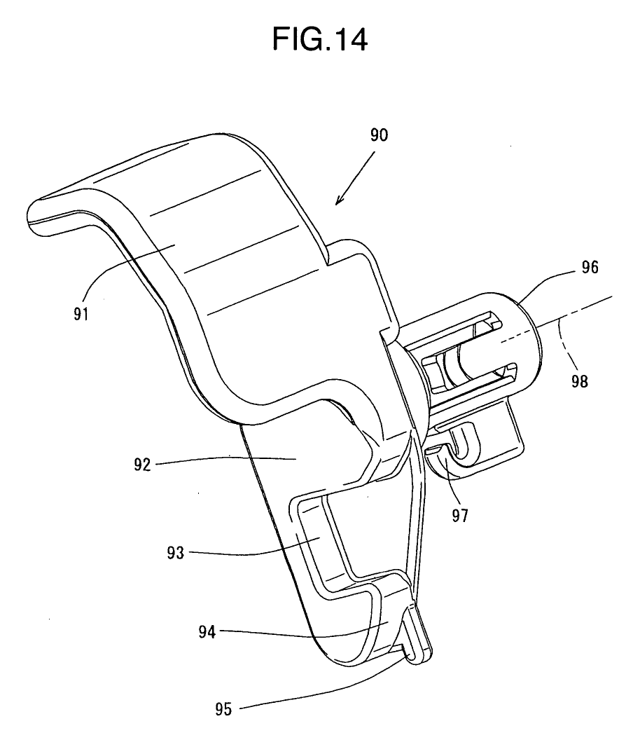

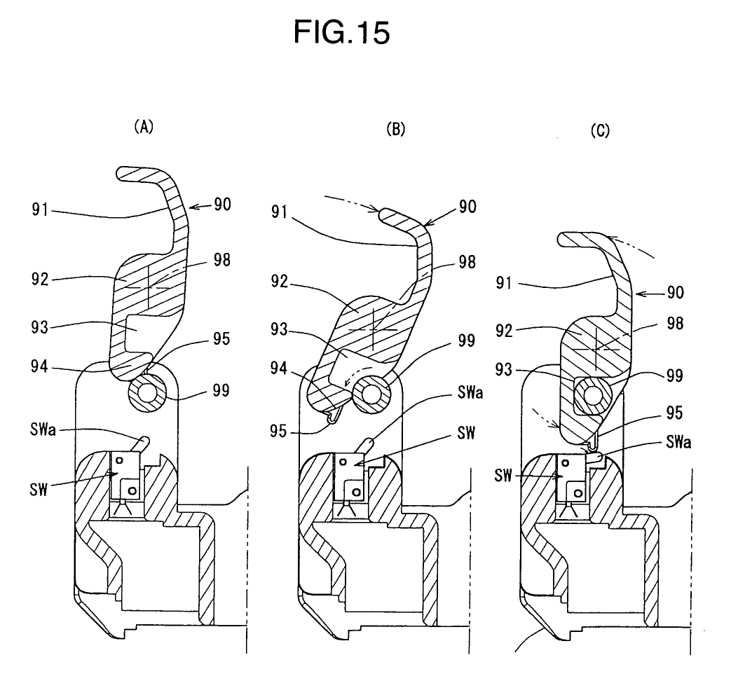

FIG. 14 shows a perspective view of the hook portion 90 as seen from a rear side, and FIG. 15 shows an explanatory view of the hooking operation.

The hook portion 90 is constituted by an operation handle 91 provided in a main body portion 92, an engagement concave portion 93, a slope surface 94, a switch pressing projection 95 and a pivot portion 96, as shown in FIG. 14.

The operation handle 91 is provided at a rear position of an upper surface of the main body portion 92 (a near side of an upper surface in FIG. 14), and is formed in such a shape that a leading end rises upward from a base portion and is bent forward in two stages.

The engagement concave portion 93 corresponds to a concave portion having such a shape that a fixed range is concaved downward approximately horizontally in a straight line toward a front side (a rear side in FIG. 14) from approximately the center, in a rear surface of the main body portion 92 (a near side in FIG. 14), and an outer side surface thereof is opened.

The fixed range is set to a range having the same distance as the diameter of the engagement bearing 99 (refer to FIG. 15), or a range having a more distance. In accordance with this structure, the engagement bearing 99 can be fitted into the engagement concave portion 93.

Further, a length in a longitudinal direction of a bottom line of the engagement concave portion 93 is formed longer than a radius of the engagement bearing 99. Accordingly, the bottom line of the engagement concave portion 93 can be firmly engaged with a lower surface of the engagement bearing 99, and it is possible to prevent the engagement concave portion 93 from being accidentally detached from the engagement bearing 99 and prevent the cover 13 with the hook portion 90 from being accidentally in an open state.

The slope surface 94 corresponds to a slope surface which rises obliquely while being bent toward the rear side (the near side in FIG. 14) from the bottom line of the main body portion 92, and an upper end thereof is connected to a rear end (a near side end in FIG. 14) of the bottom line of the engagement concave portion 93.

The switch pressing projection 95 is provided at a position of an end portion close to the pivot portion 96 in the slope surface 94 so as to protrude toward the lower side.

The pivot portion 96 is provided in a rising manner in the cover 13 side, and is rotatably pivoted to the rotating axis 98 (refer to FIG. 3) of the cover 13. A lower portion of the pivot portion 96 is provided with a spring catch projection 97 to which one end of a spring (not shown) serving as an elastic body is attached. The other end of the spring is attached to the cover 13. On the basis of the spring, the hook portion 90 is energized in such a manner that the engagement concave portion 93 is rotated in a direction of fitting to the engagement bearing 99, and the engagement bearing 99 and the engagement concave portion 93 are securely engaged.

In accordance with the structure mentioned above, if the cover 13 (refer to FIG. 13) is rotated in the direction in which the cover 13 is closed, as shown in FIG. 15A, the slope surface 94 is first brought into contact with the engagement bearing 99.

If the cover is further closed from here, since the slope surface 94 is sloped with respect to a straight line obtained by connecting the rotating shaft 98 of the hook portion 90 to the rotating shaft of the engagement bearing 99, the slope surface 94 is pressed by the engagement bearing 99 and the hook portion 90 is rotated around the rotating shaft 98, as shown in FIG. 15B. At this time, the engagement bearing 99 is inversely rotated to the hook portion 90, and smoothly executes the rotation of the hook portion 90.

If the cover 13 (refer to FIG. 13) is closed further, the engagement bearing 99 is away from the slope surface 94, and the hook portion 90 is exposed to the energizing force of the spring (not shown) by the spring catch projection 97 and is inversely rotated around the rotating shaft 98. At this time, as shown in FIG. 15C, the engagement bearing 99 securely enters into the engagement concave portion 93 so as to be engaged.

Further, at a time of this inverse rotation, the switch pressing projection 95 is brought into contact with an operation projection SWa of a switch SW provided in the base 14 so as to push down the base 14, and changes the switch SW from an off state to an on state (or from the on state to the off state).

On the contrary, in the case that the cover 13 is opened, the user lifts up the operation handle 91 while pressing the operation handle 91 toward the rotating shaft 24 (refer to FIG. 3) of the cover 13 from the state in FIG. 15C, whereby it is possible to rotate the cover 13 in the opening direction.

At this time, since the switch pressing projection 95 of the hook portion 90 is away from the operation projection SWa of the switch SW at a time point of pressing the operation handle 91, it is possible to immediately detect a matter that the switch is turned off (or turned on) and the opening operation is executed.

In this case, since the hook portion 90 provided in the expansion cover 15, and the engagement bearing 99 (not shown) provided in the expansion base 16 have the same structures of the hook portion 90 of the cover 13 mentioned above and the engagement bearing 99 of the base 14 and execute the same operations, a detailed description thereof will be omitted.

As described above, since the positioning member 42 and the positioning bearing 51 are securely brought into contact with each other so as to be positioned, the relative positions between the magnetic sensor portion 40 and the facing roller portion 50 can maintain a high positioning precision without any specific positioning adjustment however often the cover 13 is opened and closed.

Further, since the hook portion 90 and the engagement bearing 99 are provided for locking the opening and closing of the cover 13, it is possible to prevent the cover 13 from being accidentally opened and closed in the process of the carrier of the bank bill after the bank bill identification machine 10 is driven. Accordingly, it is possible to maintain the clearance C positioned by the positioning member 42 obtaining the energizing force of the spring 55 and the positioning bearing 51 during the carrier of the bank bill.

Further, since the switch SW directly detect the matter that the engagement concave portion 93 of the hook portion 90 is securely hooked and engaged with the engagement bearing 99, it is possible to detect without being affected by the other troubles, and it is possible to prevent the cover 13 from being detected as the cover 13 is closed in an unstable closed state in which the cover 13 is not firmly locked. Accordingly, it is possible to stop the operation of the bank bill identification machine 10 until the cover 13 is completely locked, and it is possible to securely prevent the trouble that the lock is detached during the carrier of the bank bill and the cover 13 is erroneously opened.

Further, since the operation handle 91 is directly provided in the hook portion 90, it is possible to securely detect the opening operation of the cover 13 at a time point of canceling the lock corresponding to a first action of the cover opening. Accordingly, if the worker intends to open the cover 13 in the process of the carrier of the bank bill by the bank bill identification machine 10, for example, at a time of an operation test of the bank bill identification machine 10 or the like, it is possible to detect the cover opening in a lock canceling step before the cover 13 starts opening, and it is possible to stop the carrier of the bank bill before the cover 13 starts opening.

Further since the support body 41 structuring the periphery of the magnetic sensor 45 is formed by the high-permeability member, it is possible to avoid the detecting precision of the magnetic sensor 45 from being affected by the support body 41. Further, since the positioning member 42 is formed by the hard member while attaching importance to the hardness as is different from the support body 41, it is possible to prevent the positioning member 42 from being deformed with age due to an abrasion or the like and prevent the clearance C from being changed.

Accordingly, it is possible to solve a contradict object that it is desirable that the periphery of the magnetic sensor 45 is structured by the high-permeability member such as an aluminum, a resin or the like, however, it is preferable to employ a hard material such as an iron, a metal alloy or the like even if the permeability is lower than the soft high-permeability member, in order to keep the clearance C between the magnetic sensor 45 and the facing roller 52 constant.

Further, since the positioning bearing 51 is firmly attached to the same shaft body 53 as the facing roller 52, it is possible to directly position the facing roller 52, and it is possible to secure a high positioning precision.

Describing in detail, for example, in the case that an appropriate contact body exists in a front side or a rear side from the facing portion between the magnetic sensor 45 and the facing roller 52 in place of the positioning member 42 and the positioning bearing 51, the positioning accuracy is lowered due to the deformation between the cover 13 and the base 14 or the like, however, the reduction of the accuracy is not generated by the structure mentioned above, and it is possible to maintain a stable positioning accuracy.

Further, since the positioning bearing 51 has the circular cross sectional shape in the same manner as the facing roller 52, the positioning bearing 51 is brought into contact with the positioning member 42 on a straight line connecting the magnetic sensor 45 provided in the magnetic sensor portion 40 and the facing roller 52, and it is possible to directly determine the clearance C.

In this case, in the embodiment mentioned above, the clearance C is formed by structuring the lower surface of the support body 41 flush with the lower surface of the positioning member 42, and structuring the radius of the positioning bearing 51 larger than the radius of the facing roller 52, however, the clearance C can be formed in accordance with various structures, such as the clearance C is formed by structuring the radius of the facing roller 52 equal to the radius of the positioning bearing 51, or the like.

Further, the positioning member 42 is buried in the support body 41 so as to be fixed, however, the structure may be made such that it is possible to adjust the protruding distance of the positioning member 42 with respect to the lower surface of the support body 41 by a firmly attaching means such as a screw or the like. In this case, since the clearance C in the closed state can be maintained however often the cover 13 is opened and closed as far as the clearance C is once adjusted, it is unnecessary to adjust the position after the maintenance work and the working efficiency is improved.

Further, the structure is made such that the stable operation is achieved by forming the energizing portion 60 in the base 14 and energizing the facing roller portion 50, however, the magnetic sensor portion 40, the facing roller portion 50 and the energizing portion 60 may be provided in the other appropriate layout with respect to the cover 13 and the base 14.

In the correspondence between the structures of the present invention and the embodiment mentioned above, the sheet identification machine in accordance with the present invention corresponds to the bank bill identification machine 10 in accordance with the embodiment, and the similar correspondences are obtained as follows.

The sensor portion corresponds to the magnetic sensor portion 40, a part of the other corresponds to the positioning member 42, the sensor corresponds to the magnetic sensor 45, the facing portion corresponds to the facing roller portion 50, a part of the one corresponds to the positioning bearing 51, the lock portion corresponds to the hook portion 90 and the engagement bearing 99, the engagement portion corresponds to the engagement bearing 99, the hooking detecting means corresponds to the switch SW, the sheet corresponds to the bank bill, the high-permeability member corresponds to the aluminum, and the metal member corresponds to the stainless steel. However, the present invention is not limited to the structures in the embodiment mentioned above, but can obtain a lot of embodiments.

It should be further understood by those skilled in the art that although the foregoing description has been made on embodiments of the invention, the invention is not limited thereto and various changes and modifications may be made without departing from the spirit of the invention and the scope of the appended claims.

1. A sheet identification machine identifying a sheet comprising:
a base;
a cover freely opened and closed with respect to said base;
a carrier path formed between facing surfaces of said base and said cover and carrying the sheet;
a sensor portion arranged in any one of said base and said cover and having a sensor detecting for identification from said sheet; and
a facing portion arranged in the other and facing to said sensor portion,
wherein the sheet identification machine is provided with an energizing portion energizing any one of said sensor portion and said facing portion in a direction moving close to the other, thereby bringing a part of said one into contact with a part of the other.

2. A sheet identification machine as claimed in claim 1, wherein the sheet identification machine is provided with a lock portion locking an opening and closing operation between said cover and said base.

3. A sheet identification machine as claimed in claim 2, wherein said lock portion is constituted by an engagement portion provided in said base, and a hook portion provided in said cover and engaging with said engagement portion, and said base is provided with a hooking detecting means for detecting a matter that said hook portion is hooked to said engagement portion.

4. A sheet identification machine as claimed in claim 3, wherein the sheet identification machine is provided with a pivot portion rotatably pivoting said hook portion to said cover, and
wherein said hook portion comprises:
a slope surface brought into contact with said engagement portion at a time of changing to a closed state so as to rotate the hook portion itself;
an engagement concave portion with which said engagement portion is engaged at a time of finishing the change to the closed state; and
an operation handle allowing an operation of rotating the hook portion itself around said pivot portion in a direction in which said engagement concave portion gets out from said engagement portion at a time of changing to the open state.

5. A sheet identification machine as claimed in claim 1, wherein said sensor is constituted by a magnetic sensor, a periphery of said magnetic sensor of said sensor portion is formed by a high-permeability member, and a part of said sensor portion brought into contact with a part of said facing portion is formed by a metal member.

6. A sheet identification machine as claimed in claim 1, wherein the sensor of said sensor portion is provided in both ends of a width by which the sheet passes through in a carrier width of the carrier path, and is densely provided in the center of the carrier path.
